(19) United States
(12) Patent Application Publication
(10) Pub. No.: US 2002/0096899 A1
(43) Pub. Date: Jul. 25, 2002

(54) Assist device for using chopsticks

(76) Inventor: Sue-May Kang, Taipei (TW)

Correspondence Address: Matthews, Collins, Shepherd & Gould, P.A., Suite 306, 100 Thanet Circle, Princeton, NJ, 08540, US

(21) Appl. No.: 10/071,041

(22) Filed: Feb. 8, 2002

Related U.S. Application Data
(62) Division of application No. 09/766,039, filed on Jan. 19, 2001.

(51) Int. Cl. A47G 21/10; A47J 43/28

(52) U.S. Cl. 294/99.2; 294/25

(57) ABSTRACT

An assist device for using chopsticks includes a finger holder having two members for fingers holding, a chopstick keeper having two parts connected to the two members of the finger holder respectively, wherein each of the two parts having a position for fixing a chopstick thereon, and an connecting member connected to one of the chopstick keeper and the finger holder for returning said assist device to an original shape. The assist device does keep the chopsticks in a best operating condition even though the user cannot use the chopsticks coordinately. Thus, the assist device can assure the chopsticks are able to pick up food correctly and efficiently even though the finger holder is non-coordinately pressed. Therefore, the assist device helps the user who is disabled to use the chopsticks for easily operating the chopsticks. In addition, the chopsticks can be removed from the chopstick keeper for cleaning, so there is no hygiene problem.

### FIELD OF THE INVENTION

The present invention relates to an assist device for using chopsticks, and more particularly to an assist device for fixing the chopsticks thereon in order that a person whose hands are disabled, or a child whose hand development is slow can easily use the chopsticks.

### BACKGROUND OF THE INVENTION

For a person who is injured due to an accident or disease, he could lose the ability for using his hands to operate the chopsticks. In addition, generally for a left-hand person or a foreigner who is not a chopstick-culture person, it is hard to use the chopsticks for having food.

According to the U.S. Pat. No. 5,611,586, a device for helping a disabled person use chopsticks is disclosed. The device includes two sleeves for holding a pair of chopsticks, a connecting element connected between the sleeves, and an operating frame having two opposite ends respectively connected to the sleeves. The operating frame is operated with the hand to move the sleeves relative to each other, thereby causing the chopsticks to act against each other for raising food to the mouth.

However, the prior art does not consider that a person whose fingers are more malfunctioned cannot easily hold the device resulting in the device falling down. In addition, the prior art only provides one type of the device for helping disabled persons, so the device according to the prior art cannot be applied in many different kinds of disabled persons.

Therefore, the purpose of the present invention is to develop an assist device to deal with the above situations encountered in the prior art.

### SUMMARY OF THE INVENTION

It is therefore an object of the present invention to propose an assist device for a person whose hands are disabled to easily hold and operate the chopsticks by moving fingers.

It is therefore another object of the present invention to propose an assist device for using the chopsticks to pick up food to the mouth easily and efficiently.

It is therefore an additional object of the present invention to propose an assist device for stably using the chopsticks to avoid crossing the tips of the chopsticks and preventing food from falling down.

It is therefore an additional object of the present invention to propose an assist device for a person who is not used to use the chopsticks to easily operate the chopsticks.

It is therefore an additional object of the present invention to propose an assist device having different alternations for different disabled persons.

According to one aspect of the present invention, there is proposed an assist device for using chopsticks. The assist device includes a finger holder having two members for fingers holding, a chopstick keeper having two parts connected to said two members of said finger holder respectively, wherein each of said two parts has a position for fixing a chopstick thereon, and a connecting member connected to one of said chopstick keeper and said finger holder for returning said assist device to an original shape.

Certainly, each member of said finger holder can have at least one sleeve for putting fingers thereon. The sleeve can be closed shaped or opened shaped.

Certainly, each member of said finger holder can have at least one windable unit for putting fingers thereon when said at least one windable unit is wound.

Certainly, each member of said finger holder can be fixed in an angle for properly putting fingers thereon. In addition, one or two of member of said finger holder can be rotatable and the angle thereof is capable of being adjusted with respect to said chopstick keeper for properly putting the deformed fingers of a disabled person thereon.

Certainly, the connecting member can be U-shape, S-shape, Z-shape, Linear-shape, M-shape, V-shape, circle-shape, sphere-shape, oval-shape or irregular geometric shape.

Preferably, the assist device further includes a guiding member connected to one selected form a group consisting of said chopstick keeper, said finger holder, and said connecting member. The guiding member is preferably a let-in structure.

Certainly, the guiding member can have a guiding groove and a guiding unit, said guiding groove is for said guiding unit to slide therein.

Certainly, the assist device can further include an accessory for performing one of functions selected from emitting sound, emitting light, changing shape, changing color and changing size. The accessory can further be connected to one selected form a group consisting of said guiding member, said finger holder, said chopstick keeper and said connecting member for performing one of functions selected from emitting sound, emitting light, changing shape, changing color and changing size, wherein said accessory has an activating element for being activated by one of said connecting member and said guiding member, thereby causing said accessory to perform said functions.

Preferably, the position of said chopstick keeper is a through hole having an elastic interior for tightly fastening chopstick therein.

Preferably, the position of chopstick keeper is a through hole having at least one elastic element protruding from the inner surface thereof.

Preferably, the chopstick keeper comprises a wedge element movable disposed in said chopstick keeper for fixing chopsticks.

Certainly, each two parts of said chopstick keeper has a first portion and a second portion, which are integrally formed with said finger holder and said connecting member, respectively.

According to another aspect of the present invention, there is proposed an assist device for using chopsticks. The assist device includes a finger holder having two members for fingers holding, a pair of chopsticks integrally formed with said finger holder, and a connecting member connected to one of said two chopsticks and said finger holder for returning said assist device to an original shape.

Preferably, the assist device further includes a guiding member connected to one selected from a group consisting of said chopsticks, said finger holder, and said connecting member.

Preferably, the guiding member is a let-in structure and the guiding member has a guiding groove and a guiding unit, said guiding groove is for said guiding unit to slide therein.

Certainly, the assist device can further include an accessory for performing one of functions selected from emitting sound, emitting light, changing shape, changing color and changing size. The accessory can further be connected to one selected from a group consisting of said guiding member, said finger holder, said chopstick keeper and said connecting member for performing one of functions selected from emitting sound, emitting light, changing shape, changing color and changing size, wherein said accessory has an activating element for being activated by one of said connecting member and said guiding member, thereby causing said accessory to perform said functions.

Preferably, each member of said finger holder has at least one sleeve for putting fingers thereon. Certainly, the sleeve can be closed shaped or opened shaped.

Certainly, each member of said finger holder has at least one windable unit for putting fingers thereon when said at least one windable unit is wound.

Certainly, each member of said finger holder can be fixed in an angle for properly putting fingers thereon.

Preferably, one or two member of said finger holder are rotatable and the angle thereof is capable of being adjusted with respect to said chopstick keeper for properly putting the deformed fingers of a disabled person fingers thereon.

Certainly, the connecting member can be U-shape, S-shape, Z-shape, Linear-shape, M-shape, V-shape, circle-shape, sphere-shape, oval-shape or irregular geometric shape.

Certainly, each two parts of said chopstick keeper has a first portion and a second portion, which are integrally formed with said finger holder and said connecting member, respectively.

The present invention may best be understood through the following description with reference to the accompanying drawings, in which:

### BRIEF DESCRIPTION OF THE DRAWINGS

FIG. 1 is a diagram of an assist device for using chopsticks according to a preferred embodiment of the present invention, wherein the assist device is operated by fingers;

FIG. 2 is a three-dimensional view illustrating an assist device for using chopsticks according to another preferred embodiment of the present invention;

FIG. 3 is a three-dimensional view illustrating an assist device for using chopsticks according to an additional preferred embodiment of the present invention;

FIG. 4 is a three-dimensional view illustrating an assist device for using chopsticks according to an additional preferred embodiment of the present invention;

FIG. 5 is a three-dimensional view illustrating an assist device for using chopsticks according to an additional preferred embodiment of the present invention;

FIG. 6 is a three-dimensional view illustrating an assist device for using chopsticks according to an additional preferred embodiment of the present invention;

FIG. 7 is a three-dimensional view illustrating an assist device for using chopsticks according to an additional preferred embodiment of the present invention;

FIG. 8 is a three-dimensional view illustrating an assist device for using chopsticks according to an additional preferred embodiment of the present invention;

FIG. 9 is a three-dimensional view illustrating an assist device for using chopsticks according to an additional preferred embodiment of the present invention;

FIG. 10 is a three-dimensional view illustrating an assist device for using chopsticks according to an additional preferred embodiment of the present invention;

FIG. 11 is a three-dimensional view illustrating an assist device for using chopsticks according to an additional preferred embodiment of the present invention;

FIG. 12 is a three-dimensional view illustrating an assist device for using chopsticks according to an additional preferred embodiment of the present invention;

FIG. 13 is a three-dimensional view illustrating an assist device for using chopsticks according to an additional preferred embodiment of the present invention;

FIG. 14 is a sectional view illustrating one part of a chopstick keeper and one member of a finger holder of the assist device for using chopsticks according to a preferred embodiment of the present invention;

FIG. 15 is a sectional view illustrating one part of a chopstick keeper and one member of a finger holder of the assist device for using chopsticks according to another preferred embodiment of the present invention;

FIG. 16 is a sectional view illustrating one part of a chopstick keeper and one member of a finger holder of the assist device for using chopsticks according to an additional preferred embodiment of the present invention; and

FIG. 17 is a sectional view illustrating one part of a chopstick keeper and one member of a finger holder of the assist device for using chopsticks according to an additional preferred embodiment of the present invention.

### DETAILED DESCRIPTION OF THE PREFERRED EMBODIMENTS

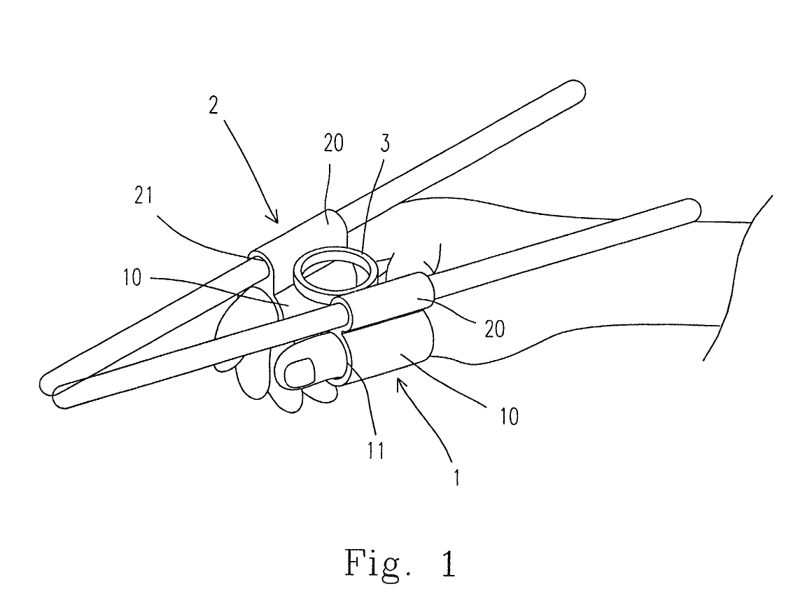

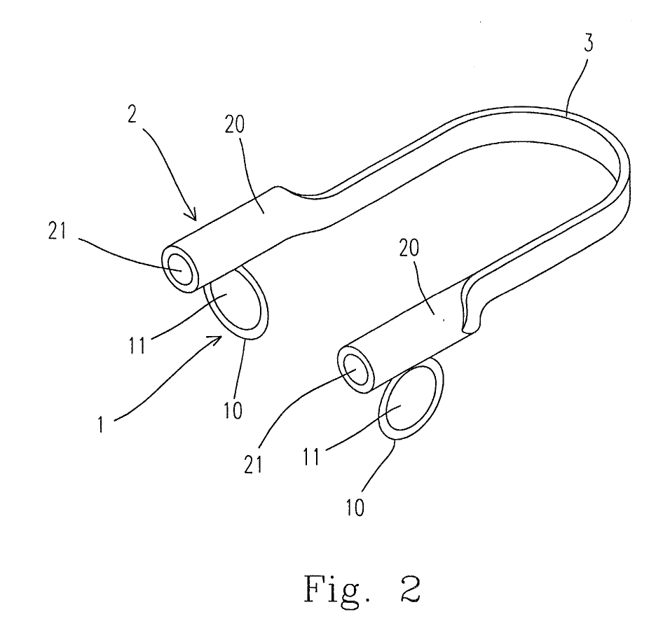

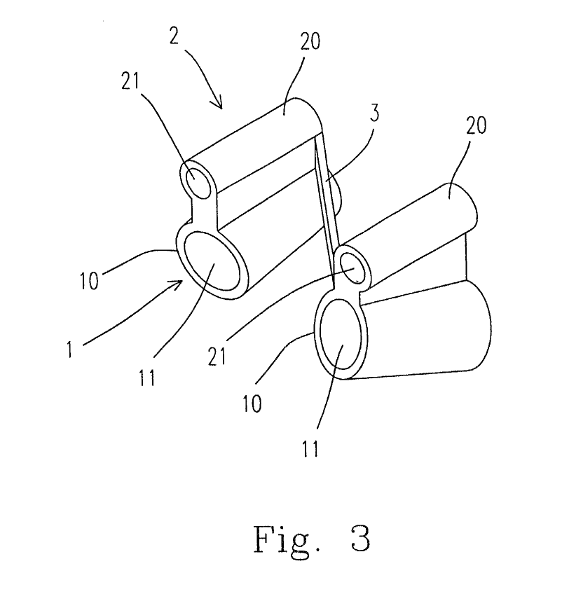

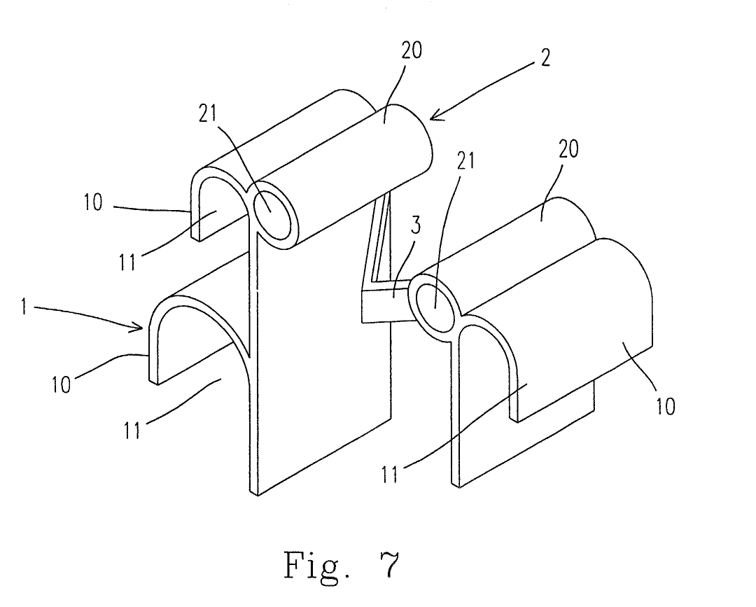

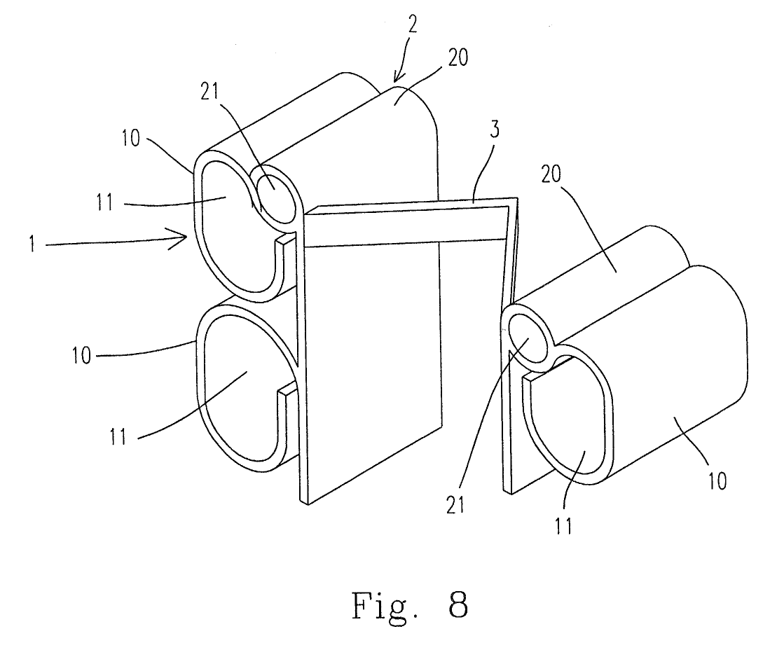

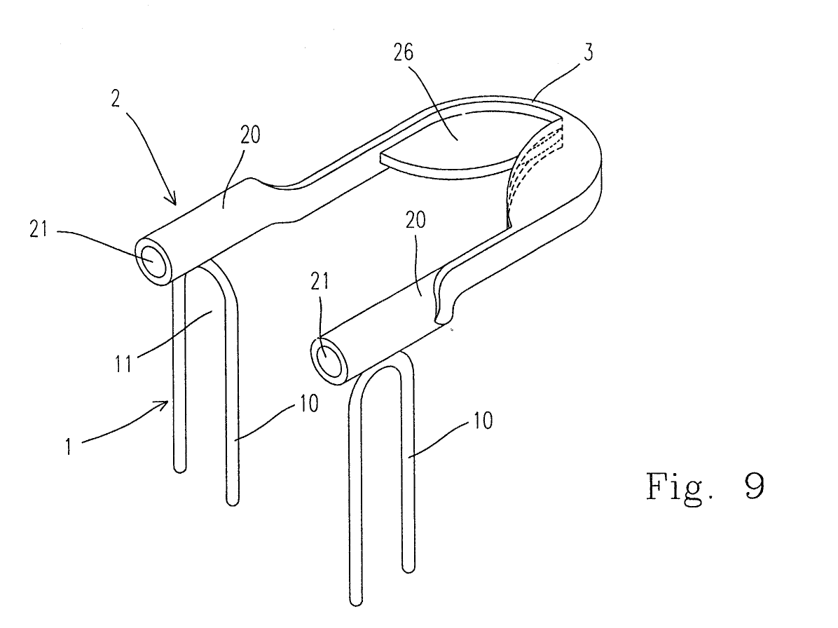

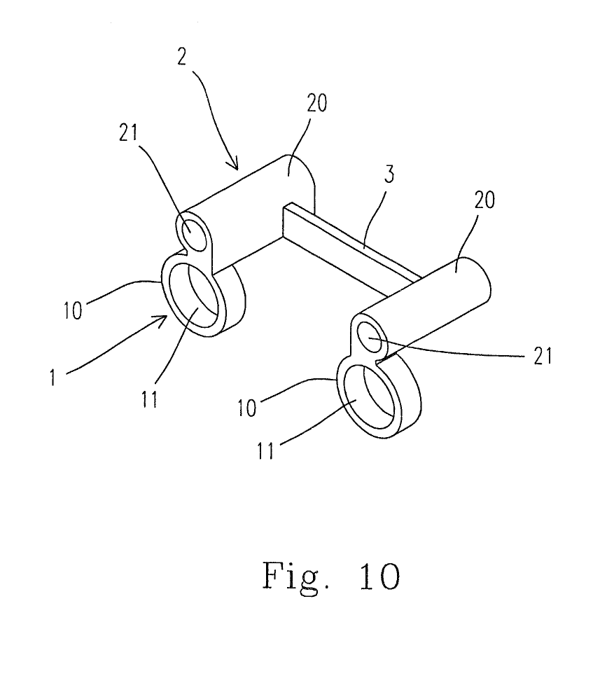

As shown in FIG. 1, the present invention provides an assist device for using chopsticks having a finger holder 1, a chopstick keeper 2 and an connecting member 3. The finger holder 1 includes two members, and each member is a sleeve 10 to form a hole 11 provided a position for user to put thumb or forefinger in. Each member of the finger holder can has one sleeve 10 (FIG. 1) or two sleeves (FIGS. 7, 8 and 12) for putting fingers thereon. Also, the member of the finger holder can be a windable shaped as shown in FIG. 9. The sleeve 10 has different size for fitting different users. The structure of the finger holder 1 can be closed sleeves 10 as shown in FIGS. 1 and 2, or opened sleeves 10 as shown in FIGS. 7 and 8. The width of the sleeve 10 can be very small as shown in FIGS. 2 and 10. The sleeve 10 and the chopstick keeper 2 are parallel to each other (FIG. 1) or not (FIGS. 2 and 3). Moreover, the finger holder 1 can be in the shape of circle, cone, irregular figure, arch, straight line and hook.

As shown in FIG. 1, the chopstick keeper 2 includes two parts 20 connected to the two members of the finger holder 1, respectively. Each part of the chopstick keeper 2 includes a position 21, e.g. a through hole, for fixing a chopstick. Moreover, the chopsticks can be directly connected to the finger holder 1.

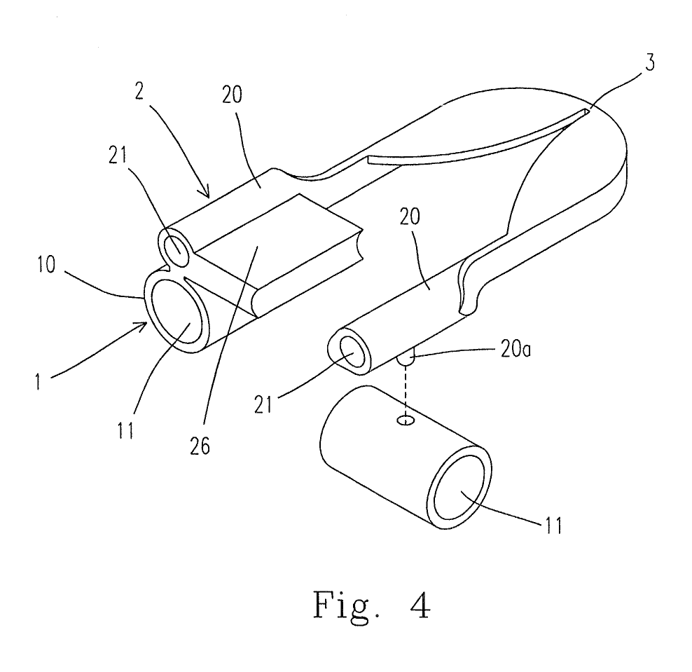

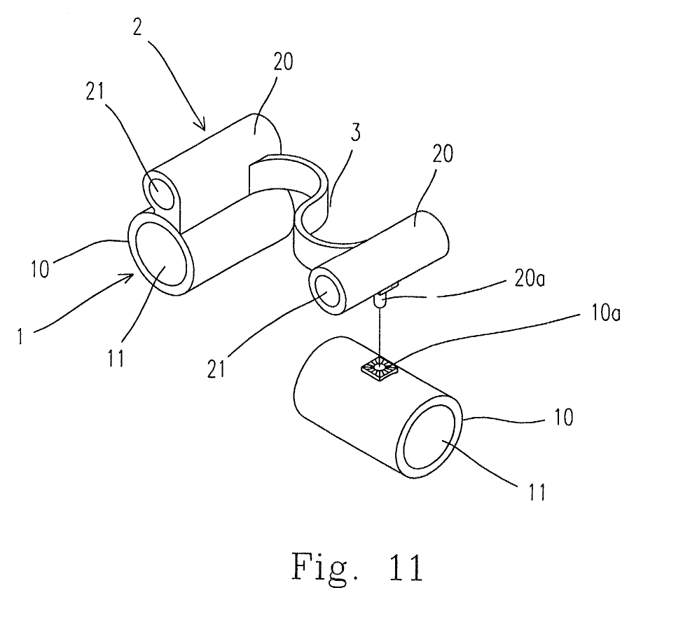

The sleeve 10 is rotatable and the angle thereof is capable of being adjusted with respect to the chopstick keeper for properly putting the deformed fingers of a disabled person thereon. As shown in FIG. 4, the sleeve 10 is pivotally connected to a protruding 20a on the part 20 of the chopstick keeper 2. Thus, the sleeve 10 can be rotated to a proper position for putting user's fingers comfortably. In addition, as shown in FIG. 11, a positioning unit 10a is disposed on the sleeve 10 in order for rotating and positioning the sleeve 10.

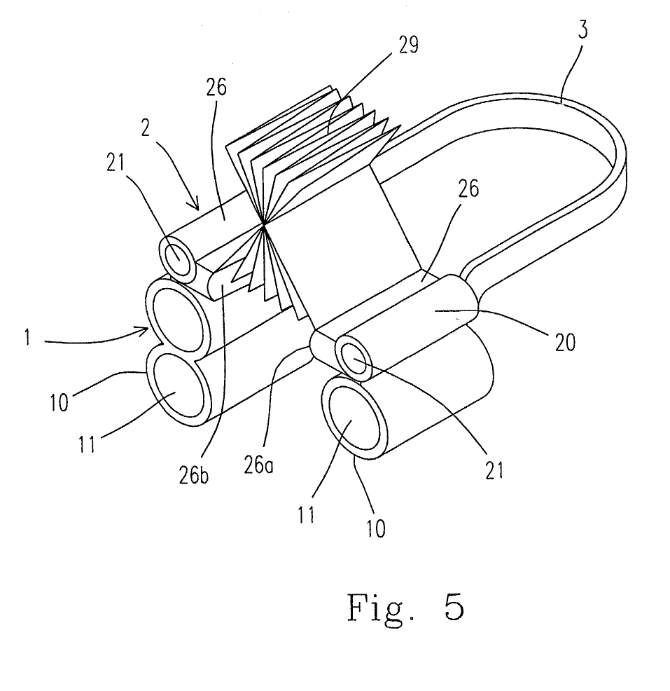

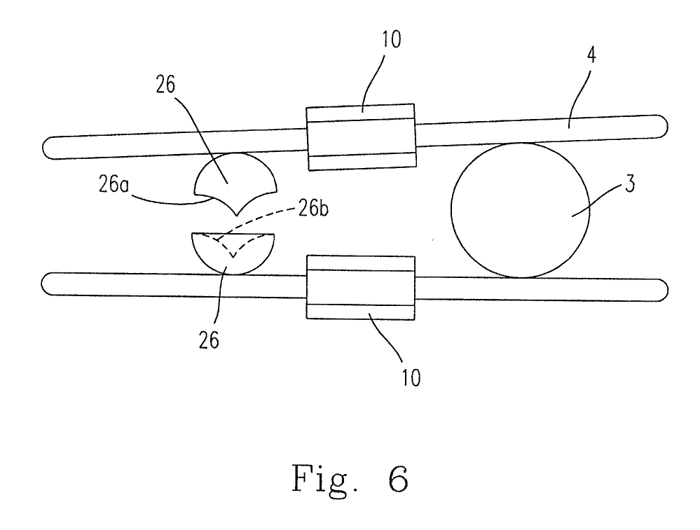

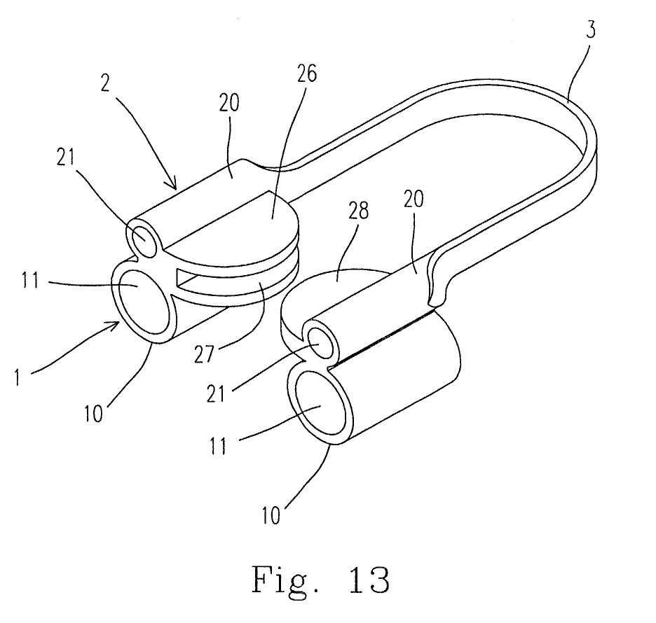

The connecting member 3 is connected to the two parts 20 of the chopstick keeper 2 such as shown in FIGS. 1, 2 and 3, the two members of the finger holder 1 such as shown in FIGS. 5, 7 and 8, in the interconnection of the finger holder 1 such as FIG. 13, or the two chopsticks 4 such as shown in FIG. 6. The connecting member 3 can be U-shaped (FIG. 2), S-shaped (FIG. 11), Z-shaped (FIG. 3), linear-shaped (FIG. 10), M-shaped or W-shaped (FIG. 7), V-shaped (FIG. 8), circle-shaped (FIG. 1), oval-shaped, sphere-shaped (FIG. 6) or other irregular geometric shapes (FIG. 4). The shape of the connecting member 3 is easily pressed to employ the chopsticks to pick things up and has a proper returning force after pressing and returning to the initial position.

Hence, as shown in FIG. 1, for using the assist device of the present invention, a pair of chopsticks 4 is inserted into the positions 21 of the chopstick keeper 2 and the tips of the chopsticks are passed therethrough. The user can put his thumb and forefinger into the hole 11 of the sleeves 10 of the finger holder 1 for operating the chopsticks 4. Therefore, the user only has to slightly move his fingers, the finger holder 1 will drive the tips of the chopsticks 4 to operate the clipping action. After finishing the clipping action, the returning force of the connecting member 3 will allow the tips of the chopsticks 4 to separate and return to the initial position easily.

The assist device according to the present invention does keep the chopsticks in a best operating condition even the user cannot use the chopsticks coordinately. That is, the present invention can assure the tips of the chopsticks can pick up food correctly and efficiently even though the finger holder is non-coordinately pressed. Therefore, the present invention provides the assist device for the user who is disabled to use the chopsticks to easily operate the chopsticks for eating. In addition, the chopsticks can be removed from the position 21 of the chopstick keeper 2 for cleaning, so there is no hygiene problem for the present invention.

Moreover, the finger holder 1, the chopstick keeper 2 and the connecting member 3 can be alternatively assembled. For example, the two parts 20 of the chopstick keeper 2 can be integrally formed with the finger holder 1 and the connecting member 3, respectively. In addition, the chopsticks 4 can be integrally formed with the finger holder 1 or the connecting member 3, e.g. the chopstick keeper 2 is omitted, so the connecting member is connected to the finger holder 1 or the chopsticks 4.

The relative position between the finger holder 1 and the chopstick keeper 2 or the chopsticks 4 is alternative. That is, the sleeves 10 of the finger holder 1 can be above, below or beside the parts 20 of the chopstick keeper 2 or the chopsticks 4. Furthermore, the sleeves 10 of the finger holder 1 are adjusted in different angles as shown in FIGS. 2 and 3.

The assist device for using the chopsticks can further includes a guiding member 26 as shown in FIG. 6. The guiding member 26 can be placed in the internal side of the parts 20 of the chopstick keeper 2 such as shown in FIGS. 4, 5 and 12, in the internal side of the chopsticks 4 such as shown in FIG. 6, in the internal side of the connecting member such as shown in FIG. 9, in the internal side or in the interconnection of the finger holder 1 such as shown in FIG. 13. As shown in FIGS. 5 and 6, the guiding member 26 includes two portions 26a and 26b which are formed a let-in structure (FIGS. 4, 5, 6, 9 and 13). The two portions of the guiding member can be in a shape of square, triangle, circle, ladder, diamond, flower, lamp or irregular geometric shaped, etc. The guiding member can be placed in one side (FIG. 4) or two sides (FIGS. 5, 6, and 13) of the chopstick keeper 2 (FIGS. 4, 5 and 12), the chopsticks 4 (FIG. 6), the connecting member (FIG. 9), the interconnecting area between the chopstick keeper 2 and the finger holder 1 (FIG. 13) or the finger holder 1. Furthermore, the guiding member can be a hollow or solid type. The guiding member is used to prevent the two parts 20 of the chopstick tips from too close or twist owing to improperly pressing. Thus, the guiding member can avoid crossing the tips of the chopsticks and preventing food from falling down.

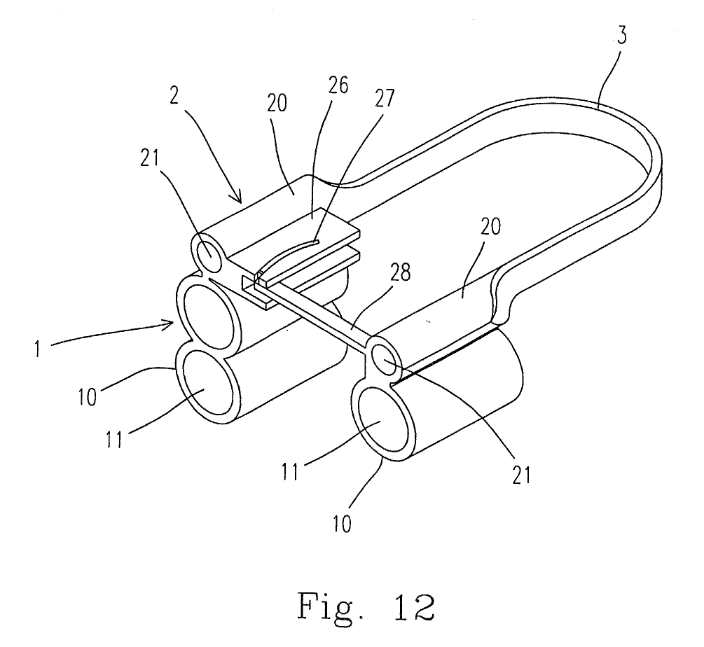

In addition, the guiding member 26 can be a guiding groove 27 and a guiding unit 28 as shown in FIG. 12. The user can stably operate the chopstick via the guiding unit 28 sliding in the guiding groove 27 to guide the clipping action. FIG. 13 is an alternative embodiment for the guiding member.

For increasing the motivation and interest, the assist device can further include an accessory 29 for performing the functions of emitting sound, emitting light, changing shape, changing color or changing size as shown in FIG. 5. Also, the accessory 29 can be connected to any part of the device, with an activating element 29a for being activated by the connecting member or the guiding member, thereby causing the accessory 29 to perform the functions.

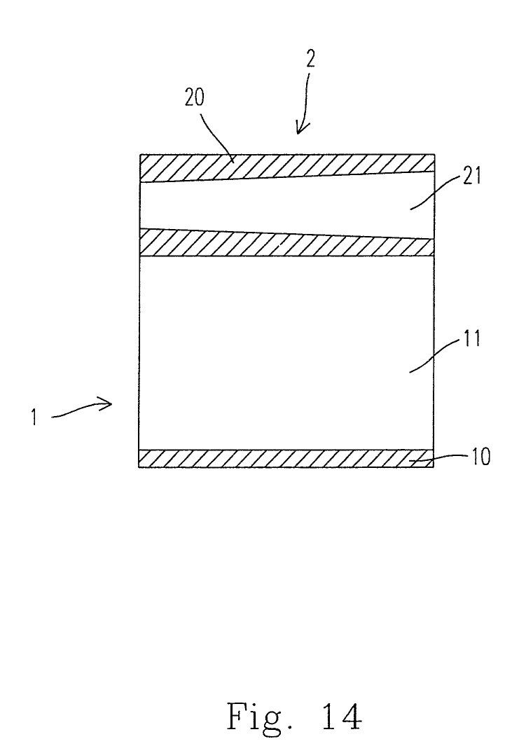

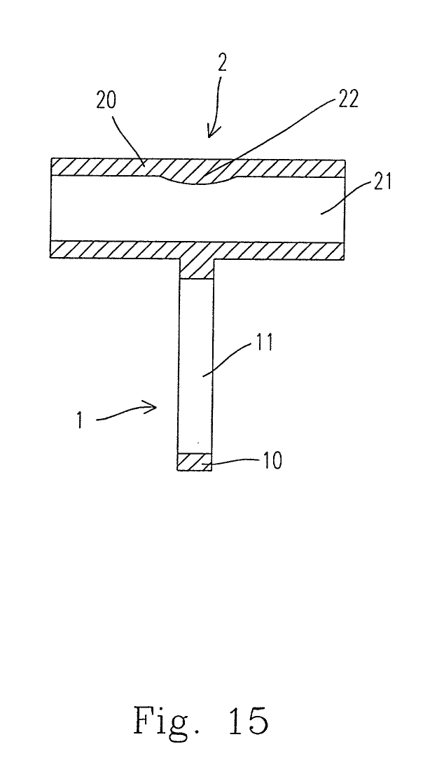

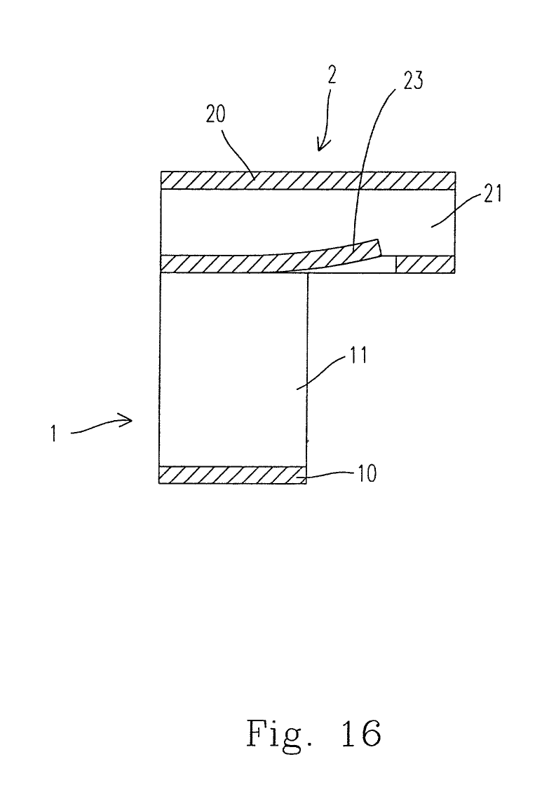

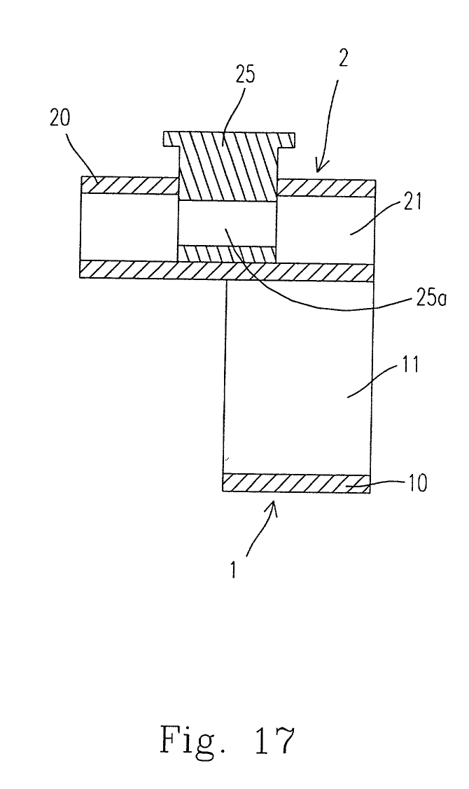

For fastening the chopsticks in the position of the chopstick keeper 2, the chopstick is fixed by elastic pressing or elastic force. As shown in FIG. 14, the position of the chopstick keeper is a taper-shaped through hole 21 for tightly fastening the chopstick therein. The position of the chopstick keeper is a through hole 21 having at least one elastic element 22 at the inner surface thereof. The position of the chopstick keeper is a through hole 21 having at least one elastic element 22 protruding from the inner surface thereof as shown in FIG. 15 in order to tightly fasten the chopstick therein. As shown in FIG. 16, a leaf spring 23 is established inner of the through hole 21 of the chopstick keeper 2 for fixing the chopstick by the elastic force. In addition, as shown in FIG. 17, the chopstick keeper 2 includes a wedge element 25 movable disposed in the chopstick keeper 2 for fastening the chopstick by screwing. Thus, while the chopstick is placed into the through hole 21, the wedge element 25 can be screwed to tightly press for fastening the chopstick therein.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An assist device for using chopsticks, comprising:
a finger holder having two members for fingers holding;
a chopstick keeper having two parts connected to said two members of said finger holder respectively, wherein each of said two parts has a position for fixing a chopstick thereon; and
a connecting member connected to one of said chopstick keeper and said finger holder for returning said assist device to an original shape.

2. The assist device according to claim 1, wherein each said member of said finger holder has at least one sleeve for putting fingers thereon.

3. The assist device according to claim 2, wherein said sleeve is one of closed shaped and opened shaped.

4. The assist device according to claim 1, wherein each said member of said finger holder has at least one windable unit for putting fingers thereon when said at least one windable unit is wound.

5. The assist device according to claim 1, wherein each said member of said finger holder is fixed in an angle for properly putting fingers thereon.

6. The assist device according to claim 1, wherein one of said member of said finger holder is rotatable and the angle thereof is capable of being adjusted with respect to said chopstick keeper for properly putting a deformed finger of a person thereon.

7. The assist device according to claim 1, wherein each said member of said finger holder is rotatable and the angle thereof is capable of being adjusted with respect to said chopstick keeper for properly putting fingers thereon.

8. The assist device according to claim 1, wherein said connecting member has a shape selected from a group consisting of U-shape, S-shape, Z-shape, Linear-shape, M-shape, V-shape, circle-shape, sphere-shape, oval-shape and irregular geometric shape.

9. The assist device according to claim 1, further comprising a guiding member connected to one selected form a group consisting of said chopstick keeper, said finger holder, and said connecting member.

10. The assist device according to claim 9, wherein said guiding member is a let-in structure.

11. The assist device according to claim 9, wherein said guiding member has a guiding groove and a guiding unit, said guiding groove is for said guiding unit to slide therein.

12. The assist device according to claim 1, further comprising an accessory for performing one of functions selected from emitting sound, emitting light, changing shape, changing color and changing size.

13. The assist device according to claim 12, wherein said accessory is connected to one selected form a group consisting of said guiding member, said finger holder, said chopstick keeper and said connecting member for performing one of functions selected from emitting sound, emitting light, changing shape, changing color and changing size, wherein said accessory has an activating element for being activated by one of said connecting member and said guiding member, thereby causing said accessory to perform said functions.

14. The assist device according to claim 1, wherein said position of said chopstick keeper is a tapered shape through hole for fastening chopstick therein.

15. The assist device according to claim 1, wherein said position of chopstick keeper is a through hole having at least one elastic element at the inner surface thereof.

16. The assist device according to claim 1, wherein said position of chopstick keeper is a through hole having at least one jut element protruding from the inner surface thereof.

17. The assist device according to claim 1, wherein said position of chopstick keeper is a through hole having a leaf spring at the inner surface thereof.

18. The assist device according to claim 1, wherein said chopstick keeper comprises a wedge element movable disposed in said chopstick keeper for fixing chopsticks.

19. The assist device according to claim 1, wherein each said two parts of said chopstick keeper has a first portion and a second portion, which are integrally formed with said finger holder and said connecting member, respectively.

19. An assist device for using chopsticks, comprising:
a finger holder having two members for fingers holding;
a pair of chopsticks integrally formed with said finger holder; and
a connecting member connected to one of said two chopsticks and said finger holder for returning said assist device to an original shape.

20. The assist device according to claim 19, further comprising a guiding member connected to one selected from a group consisting of said chopsticks, said finger holder, and said connecting member.

21. The assist device according to claim 19, wherein said guiding member is a let-in structure.

22. The assist device according to claim 19, wherein said guiding member has a guiding groove and a guiding unit, said guiding groove is for said guiding unit to slide therein.

23. The assist device according to claim 19, further comprising an accessory for performing one of functions selected from emitting sound, emitting light, changing shape, changing color and changing size.

24. The assist device according to claim 23, wherein said accessory is connected to one selected from a group consisting of said guiding member, said finger holder, said chopstick keeper and said connecting member for performing one of functions selected from emitting sound, emitting light, changing shape, changing color and changing size, wherein said accessory has an activating element for being activated by one of said connecting member and said guiding member, thereby causing said accessory to perform said functions.

25. The assist device according to claim 19, wherein each said member of said finger holder has at least one sleeve for putting fingers thereon.

26. The assist device according to claim 25, wherein said sleeve is one of closed shaped and opened shaped.

27. The assist device according to claim 19, wherein each said member of said finger holder has at least one windable unit for putting fingers thereon when said at least one windable unit is wound.

28. The assist device according to claim 19, wherein each said member of said finger holder is fixed in an angle for properly putting fingers thereon.

29. The assist device according to claim 19, wherein one of said member of said finger holder is rotatable and the angle thereof is capable of being adjusted with respect to said chopstick keeper for properly putting fingers thereon.

30. The assist device according to claim 19, wherein each said member of said finger holder is rotatable and capable of being adjusted the angle thereof with respect to said chopstick for properly putting fingers thereon.

31. The assist device according to claim 19, wherein said connecting member has a shape selected from a group consisting of U-shape, S-shape, Z-shape, Linear-shape, M-shape, V-shape, circle-shape, sphere-shape, oval-shape and irregular geometric shape.

32. The assist device according to claim 19, wherein each said two parts of said chopstick keeper has a first portion and a second portion, which are integrally formed with said finger holder and said connecting member, respectively.
